(19) United States
(12) Patent Application Publication
(10) Pub. No.: US 2020/0053957 A1
(43) Pub. Date: Feb. 20, 2020

(54) SYSTEMS AND METHODS FOR TREATMENT OF FARM FIELDS AND MANAGING HEALTH AND SAFETY OF AGRICULTURAL PRODUCTS

(71) Applicant: AgBiome, Inc., Durham, NC (US)

(72) Inventors: John C. Rabby, Wake Forest, NC (US); David L. Gerrard, Charlotte, NC (US)

(73) Assignee: AgBiome, Inc., Durham, NC (US)

(21) Appl. No.: 16/540,353

(22) Filed: Aug. 14, 2019

Related U.S. Application Data
(60) Provisional application No. 62/718,629, filed on Aug. 14, 2018.
(60) Provisional application No. 62/832,458, filed on Apr. 11, 2019.

(51) Int. Cl. A01C 21/00; G06Q 10/00; G06Q 50/02; H04W 4/029

(52) U.S. Cl. CPC A01C 21/005; G06Q 10/20; H04W 4/029; A01C 21/007; G06Q 50/02

(57) ABSTRACT

Treatment of a farm field can include accepting, by a user on a networked computing device, a treatment ticket. The treatment ticket can include one or more treatment products to be applied to a farm field, a quantity of the treatment product, and a field identifier of the field on which the treatment products are to be applied. The computing device can verify a preparation of the treatment products, including scanning a label of physical treatment products. The computing device can verify an application of the treatment products at the field, including storing a geolocation of the user. A data vector can be generated to store data relating to the performance of the treatment ticket.

### FIELD OF THE INVENTION

The invention is drawn to methods and systems for treatment of farm fields and managing and maintaining health and safety of agricultural products.

### BACKGROUND

Agricultural producers use a variety of practices to reduce yield losses to pests. Producers may choose crops, adjust plant and harvest dates, and plan for crop rotations to limit the effect of pests such as weeds, insects, and fungi. Weed control can include tilling and hoeing by hand. Treatments for managing insects and other pests can include spraying or chemigation. Seeds for some crops can also be genetically engineered to be insect-resistant and herbicide-tolerant.

### SUMMARY

Supply chains, especially those for fresh fruits and vegetables, lack full traceability back to the field of origin for certification of compliance. Further, there is no mechanism for electronic record keeping regarding the number of production best practices including safe pesticide use and exposure standards, worker safety norms and organic certification, among others. While requirements are in place to capture this data at the farm and either report it to the appropriate federal agency or have it available for periodic audit by government agencies and buyers, efficient platforms to certify these activities in real time and/or tag farm activities to specific farm fields do not currently exist. Furthermore, where records do exist, they are generated and passed through the production system in paper form, often resulting in errors in time and place of application, delays in recording and certifying practice, and unusually high administrative burdens on the farm enterprise. Most compliance is done on a post hoc audit basis from retained paper records, or by signing general compliance statements with the right to audit embedded. These approaches do not prevent potentially harmful or out of specification production from entering distribution channels nor do they flag or identify out of specification applications on fields and crops before they occur.

An improved and centralized method and system for managing the health, safety, and regulatory compliance of treatments of agricultural products in a farm field is desirable. Tracking information can include timestamped information relating ticket generation, preparation of treatment products to a farm field, application of the treatment products to a farm field, and real-time digital confirmations and acknowledgements by administrators, field supervisors, and farm employees. Processes and tracking described herein can improve the overall reliability of the treatment process by providing verification points along the treatment process, and provide more accurate and reliable records with regard to the treatment of a field or of a crop.

Methods and systems for treating a farm field, while managing and maintaining health and safety of the agricultural products and of the farm employees are provided herein. The methods and systems include health and safety response mechanisms, generated automatically by one or more processors, as described herein. Generating an electronic record or ‘ticket’ can be used to indicate a task to be performed in a farm field. Receipt of the electronic record and acceptance of the task by a certified applicator or worker can provide a chain of provenance of the field and crops. The methods and systems described herein certify that a) the products indicated in the work order or ‘ticket’ are the ones actually executed in the field environment, and b) the target field for the application or task is the one where the electronic record was executed.

Records of field treatments can be continuously maintained in compliance with standards and best practices over time. These records can be used to estimate the cumulative impact of these activities on overall compliance, best practice requirements, and environmental impact. Completion of a treatment can be communicated to an administrator of the system, in real-time, automatically. A summary certification of compliance can be generated for the totality of practice on any given field or lot against health and safety standards or best practice requirements.

Generally, a method, implemented by one or more processors, for treating a farm field, includes: accepting, by an authenticated user, a treatment ticket, the treatment ticket including a) one or more treatment products to be applied to a field in a farm, b) a quantity of the treatment product, and c) a field identifier of the field on which the one or more treatment products are to be applied; verifying a preparation of the one or more treatment products, including scanning of a label of one or more physical treatment products; verifying an application of the one or more treatment products at the field, including storing a geolocation of the authenticated user; and generating a data vector, the data vector including, i) verification of the preparation of the one or more treatment products, and ii) verification of the application of the treatment product at the field.

The presently disclosed systems and methods maintain the provenance of agricultural products (e.g., crops) and history of a farm field, while simultaneously providing a management tool for farm administrators and supervisors to manage and generate tasks for farm employees to carry out.

Systems (e.g., machines and articles of manufacture) for performing the presently disclosed methods are also provided. For example, a system or computer program product on a computing device is provided, wherein the computer program product comprises a non-transitory storage medium readable by a processing circuit of the computing device and storing instructions for execution by the processing circuit for performing any of the presently disclosed methods.

### BRIEF DESCRIPTION OF THE DRAWINGS

Embodiments of the disclosure are illustrated by way of example and not limitation in the figures of the accompanying drawings in which like references indicate similar elements.

FIG. 1 shows a process, according to one embodiment.

FIG. 2 shows a block diagram of a system, according to one embodiment.

FIG. 3 shows a sequence diagram according to one embodiment.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. Modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Agricultural products can include commodities such as fruits and vegetables and such produce can be treated by applying agricultural treatment products such as herbicides, fungicides, insecticides, nematicides, fumigants, growth regulators and fertilizers either alone or in combination with each other. The various agricultural treatment products can include either a synthetic chemistry or a biological or a combination thereof. Health and safety relating to the use of these agricultural treatment products and consumption of resulting crop/commodities can be an issue because it may be unknown how the crop was treated prior to harvesting. The treatment products can be applied to crop and/or soil in a field. Treatments with agricultural products can increase production efficiency and prevent damage to crops when performed properly and within guidelines and good practice. It can be difficult, however, to determine the treatment history of a field or crop. The treatment history can be used to determine overall compliance with usage standards and reporting of practice to stakeholders such as government agencies, buyers, and others.

### I. Process for Treatment of Farm Field

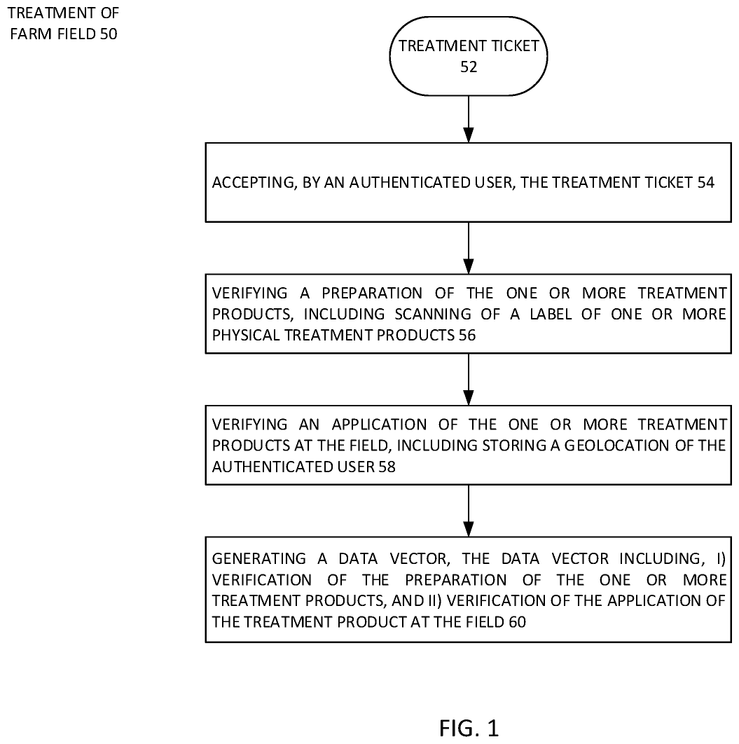

In one embodiment, as shown in FIG. 1, a process for treatment of a farm field is shown. The process can be performed by a computing device or a processor of the device. The device can be a network connected device, connected through a wireless connection protocol such as Wi-Fi, 3G, 4G, 5G, or other known protocols. The device can have a scanning module (e.g., a camera) and a global positioning system (GPS) module.

A treatment ticket 52 can be generated that assigns a task to be performed in relation to treatment of a farm field with one or more treatment products. For example, the treatment ticket can include a) one or more treatment products to be applied to a field in a farm, b) a quantity (e.g. a total quantity) or spray rate of the treatment product to be applied, and c) a field identifier of the field on which the one or more treatment products are to be applied. The treatment ticket can be a data object stored in electronic memory. The treatment ticket can include an assigned employee to perform the task (e.g., name and license number), the supervisor (e.g., name and license number), and/or the equipment (make and model of the sprayer or chemigation well) that will be used for the application. The treatment ticket can include an area of the field to be treated (e.g. an acreage), an application method, and gallons of water used per acre.

In one embodiment, the quantity or spray rate of the treatment product to be applied is optional. The quantity or spray rate can be obtained through a product label, lookup table, or other means. The quantity or spray rate can be provided in relation to an area of coverage, thus, based on the field size, an applicator can cross-reference the provided quantity or spray rate with the field to determine the total quantity to be applied.

In one embodiment, when a ticket generator selects a product to be used in a task, data can be automatically generated and included in the treatment ticket or stored elsewhere in electronic memory to be called upon during application of the treatment product. Such data can include: a pesticide registration number, a product name and manufacturer, product active ingredients, and product requirements including pre harvest interval (PHI), re-entry interval (REI), maximum residue limits (MRL), product antagonisms, personal protective equipment (PPE), and more.

At block 54, the process includes accepting, by an authenticated user, the treatment ticket. In one embodiment, the authenticated user must use a log-in to the device with log-in credentials, e.g. a username and password. Only if log-in is successful, then the user is allowed to proceed with accepting the treatment ticket. In another embodiment, an applicator device ID (a unique identifier assigned to a device) of the device can be used to screen whether or not acceptance is allowed. For example, one or more applicator device IDs can be stored in a farm database. In one embodiment, the treatment ticket can specify one or more farm employees that can perform the ticket. If the user is included in the specified farm employees, then the user is ‘authenticated’ and can accept the ticket.

The applicator device ID can be screened against the one or more applicator device IDs to determine whether the applicator device ID of the accepting party can accept the treatment ticket. For example, if the applicator device ID is present in the database, or if a flag or value is set to indicate an accepting privilege of the device, then the user is ‘authenticated’ and can accept the treatment ticket. The applicator device ID can be based on a public key of a public and private key pair used in a cryptographic system. In one embodiment, the device ID is generated in relation to an instance of the operating system of the device. In another embodiment, the device ID can be a serial number of a device. Other authentication means can be used.

At block 56, the process includes verifying a preparation of the one or more treatment products, including scanning of a label of the one or more physical treatment products. For example, the authenticated user, with device in-hand, can scan a label on a physical bag or container that contains treatment products. Labels for different products and from different manufacturers can vary. Labels can include a bar code, a quick response (QR) code, a product name or product ID, or product environmental protection agency (EPA) registration number. The device can scan the label with a camera or optical sensor. In the case where the label contains only text, the device can utilize optical character recognition (OCR) to determine the product (e.g. based on product name, ID, or EPA registration number) based on an image of the label.

The product indicated by the label of the physical treatment product can be cross-referenced with the one or more treatment products of the treatment ticket, to determine whether the one or more physical treatment products (indicated by the scanned labels) are consistent with the one or more treatment products of the treatment ticket, to verify proper preparation of the one or more treatment products.

In one embodiment, verifying the preparation of the one or more treatment products can include generating a photo of personal protective equipment (PPE). In one embodiment, the photo can be required in verifying the preparation of the treatment products. This can ensure proper procedure and improve safety when handling potentially hazardous treatment products. The photo can be stored in electronic memory and associated with a data vector that captures the activities associated with the treatment ticket.

At block 58, the process can include verifying an application of the one or more treatment products at the field, including determining, recording, and/or storing a geolocation of the authenticated user. The device can have a GPS module (e.g. a GPS receiver and supporting hardware and software) that can be used to determine the geolocation of the authenticated user. Additionally or alternatively, a device can communicate with cell towers and use a cell tower position and distance to calculate the geo location. The geolocation of the user can be cross-referenced with a known location of the field. For example, the treatment ticket can include a field ID of the farm. If the two locations are consistent (e.g. the geolocation of the user matches the geolocation of the identified field), then the device can determine that the application of the one or more treatment products is being performed in the correct location. A geolocation can include a longitude and latitude coordinate.

In one embodiment, user inputs can be generated by a user interface of the device. For example, the device can have one or more controls (e.g., graphical buttons on a display). During the application of the treatment product on the field, the user can press a ‘start’ and ‘stop’ button to indicate when the product is sprayed or irrigated onto the field. A data point can be generated based on the user interface input with a time stamp and geolocation of the authenticated user. This data point can show provenance of the treatment at that time and at that location. Other information can be included in the data point, and the data point can be included in or associated with the data vector.

At block 60, the process can include generating a data vector, the data vector including, i) verification of the preparation of the one or more treatment products, and ii) verification of the application of the treatment product at the field. The data vector can be generated as a result of the closing out of the ticket, or it can be generated and updated in real-time at each point in the process, so that an administrator and/or supervisor can view the progress of a treatment ticket.

The data vectors can be stored in one or more databases provide a history of product treatments on a per-field basis. Data can be used to check for compliance against health and safety regulations. The data vector, or the electronic treatment ticket, can include a real-time status indicator of the treatment ticket such as ‘open’, ‘in progress’, ‘complete’, and/or ‘closed’.

This process describes acceptance and performance of a treatment ticket, and touches upon other aspects of the present disclosure such as the data vector and the generation of the treatment ticket. Other aspects are described herein the present disclosure.

### II. System for Treatment of Farm Field

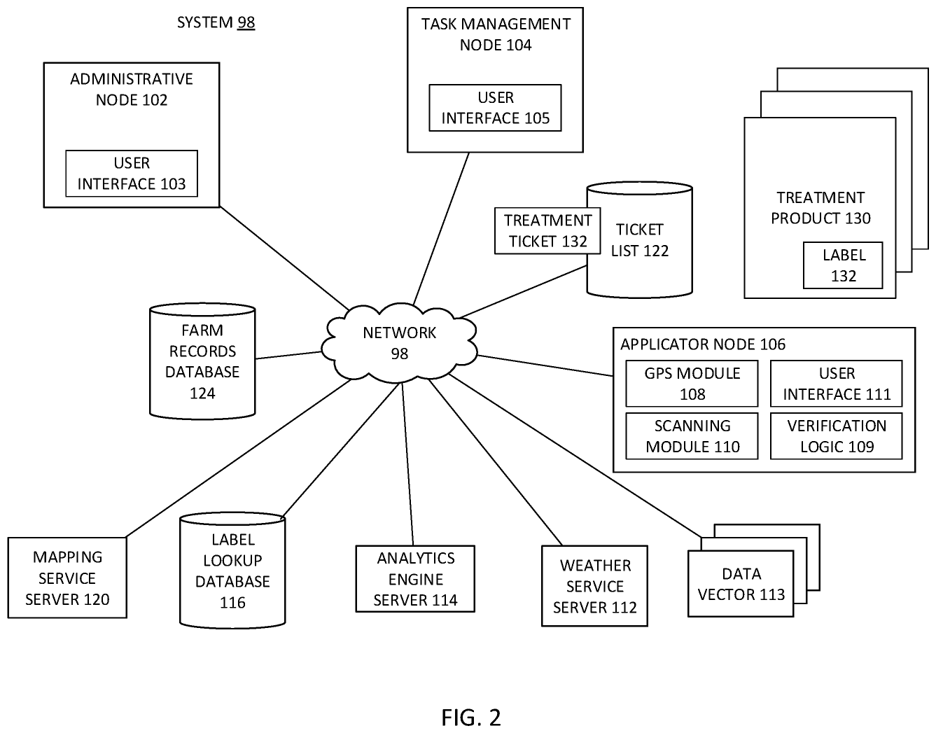

Referring to FIG. 2, a system 98 for treatment of a farm field and management of farm tasks includes one or more nodes connected to a network 98. Each node can include a computing device having one or more processors, memory, an operating system, communications modules that allow for communication between nodes on the network, and other known computer hardware and software capabilities. The nodes can be laptop computers, desktop computers, tablet computers, and/or mobile phones. Although shown as separate, the administrative node, task management node, and/or applicator node can be the same node. Similarly, unless context or common sense dictates otherwise, features of each node and the methods described herein can be offloaded to a networked computing device not shown.

Administrative Node

An administrative node 102 can include a user interface 103 that receives user inputs. A farm administrator can log into the administrative node through the user interface, with a farm administrator's credentials (e.g., username, password). The administrative node can additionally or alternatively be authenticated with a device ID and key of the administrative node. An authenticated farm administrator can manage one or more farm records databases 124. For protection and safe keeping, write-privileges of the database can be limited to only the farm administrator.

The database can include various information relating to the farm that can be referenced to treat field of the farm. For example, in one embodiment, the database can include a farm profile, the profile including one or more of the following: a farm name, a farm location, one or more farm administrators, contact information (e.g., phone number, address) of each farm administrator, and a farm identifier (e.g., and ASCS identifier).

The database can include field data of the farm. For example, the database can include a list of fields of the farm, a geolocation (e.g. a geographic information system (GIS) location) of each field of the farm, the crop being grown in each field in the current production cycle, one or more harvest dates (by field, crop, or plant) of each field, and one or more field identifiers (e.g. field nicknames). Each field can include individual compliance requirements (e.g., organic certification requirements or other health, quality, or safety requirements). Thus, one farm can have different fields that meet different requirements. Field data can also include any special field circumstances impacting compliance, e.g., neighboring housing, sensitive waterways, local ordinances, and state or federal laws. The field data can be included in a generated treatment ticket, and used to verify the proper application of the treatment products, as described in other sections.

The database can include an employee roster of the farm including one or more farm administrators, one or more farm supervisors (e.g., a crew chief), one or more treatment product applicators (e.g., employees that are licensed to apply treatment products on the fields); and one or more applicator device identifiers. The name and license number of each of the employees can be included. The employee roster can be used to manage who can generate tasks (e.g., a treatment ticket) and who can accept and perform the tasks. Additionally or alternatively, the applicator device IDs can be used to authenticate a user when the user is trying to ‘accept’ a treatment ticket. In this manner, the treatment of fields can be managed and controlled based on employee roster and applicator device IDs. The ‘applicator device’ can be the applicator node 106.

The database can include a catalog of farm equipment. For example, the farm equipment data can include farm spray equipment (e.g., make, model, serial number), and capabilities such as the spray rate or tank capacity of each farm spray equipment. The farm equipment can further include equipment used for chemigation such as chemigation well equipment (make, model, serial number, well capacity); a chemigation well identifier; a chemigation well nickname; and/or a well inspection number. In one embodiment, when generating a ticket, a user interface 105 of the task management node 104 can include a list of the farm equipment so that the user can generate the ticket and specify which equipment will be used to carry out the application of the treatment in the treatment ticket.

Task Management Node

A user can log into a task management node 104 and generate one or more tasks including a treatment ticket 132 that includes instructions to treat a field with one or more treatment products. The user can log in with log-in credentials and the user can be authenticated via device ID, or other authentication means described in the present disclosure. A user interface 105 can provide several options to help the user generate a ticket, such as any combination of the following: a) a list of employees (e.g., applicators and supervisors) that can be selected to perform and oversee the ticketed task, b) a list of treatment products that can be included in the ticket and/or the valid quantity or spray rates of those products, c) a list of farm equipment (sprayers and chemigation wells) available to carry out the application of the treatment products, d) a list of fields and/or the crops present at each field, e) harvest dates of each field, and f) other data stored in the farm records database 124. The user can also specify a date and time in which the task is to be performed and the name and address of the performing and supervising parties, as well as their IDs and/or license numbers. The user can generate a ticket that includes the specified details and selections made above and finalize the ticket.

Once finalized, the ticket can be stored in electronic memory. In one embodiment, the treatment ticket is added to a ticket list 122 having one or more tickets. The tickets can be stored with other farm tasks as part of a larger farm management task list, or the tickets can have a dedicated data structure. In one embodiment a notification can be generated and sent to an employee if the employee is assigned to the ticket. In one embodiment, if an employee logs into the system through any node, the employee can pull up any tickets that are assigned to the employee. In one embodiment, when a ticket is closed, the ticket is automatically removed from the ticket list. Additionally or alternatively, identifiers such as ‘open’, ‘in progress’, ‘complete’ and ‘closed’ can be associated with each ticket. The closed tickets can be ignored during queries to search for tickets that are not closed. The ticket list can be managed by any of the nodes shown on the network or by a networked server not shown.

In one embodiment, ticket analytics can be performed on the generated ticket and data stored in the farm records database 124. For example, prior to opening the ticket, the selected treatment products can be processed to determine whether any incompatibilities arise with regard to the products selected (e.g., the labels specify that they cannot be mixed). A label lookup database 116 can be accessed to pull label information of each treatment product, determine whether incompatibilities of the treatment products are present, and generate mixing and use instructions. In another example, the products can be cross-referenced with the field or crop requirements of the field to be treated, to determine whether application of such products would violate those requirements. Historical treatments of the field can also be referenced in determining whether the current proposed treatment, when combined with the past treatments, might violate any of the field or crop requirements (e.g., health, safety, environmental, quality control, organic certifications, or other requirements). PPE, PHI, REI, and other instructions and limitations can be automatically generated based on label lookup database 116 and included in the treatment ticket. The label lookup database can include EPA registration numbers of all treatment products, crops and rates for each product, mixing and handling instructions, and other special instructions. The label lookup database can be accessed through an application programming interface (API).

In one embodiment, the ticket will be opened only if certain criteria are met, such as the treatment products are compatible with each other and compatible with the field and/or crops that they are being applied to, and with regard to the requirements that are associated with each field. This provides a health and safety check to automatically ensure that tasks include proper instructions and treatment products.

Applicator Node

A farm employee can log into an applicator node 106. A user interface 111 can populate a list of tasks for the farm employee. The list can be extracted from the ticket list 122, filtering only on the tasks that are assigned to the particular user that is logged in at the moment. Additionally or alternatively, the user can receive an automatically generated notification (e.g. a text message, a push notification on an application, an email, etc.) when a ticket is generated and assigned to them.

The user at the applicator node can scan a label 132 of a physical treatment product 130 (e.g., a bag of pesticide). The scan can be performed with a scanning module 110 such as a camera or an optical sensor. In some cases, multiple treatment products can be selected. A verification logic module 109 can verify the proper preparation and application of the treatment product. For example, the applicator node can verify that the scanned label is consistent with (e.g., the same as) the treatment product specified in the task ticket. This can ensure that the instructions of the treatment ticket are being properly followed. A GPS module 108 can determine a geolocation of the user and verify that the location is consistent with the geolocation of the field mentioned on the task ticket. Other verification logic is described in greater detail in other sections.

In one aspect, the weather at the location of the field can be generated at the time of application. A weather service server 112, connected to the network, can be accessed to retrieve weather (e.g. temperature, barometer, wind, rain, snow, etc.) at the location of the field and device at the time of application. This weather data can be stored in the data vector along with the rest of the data, to establish the weather at the time of application.

In one embodiment, a mapping service server 120 can provide data to build geocoding maps. The server 120 can provide a zipped file (KMZ) of one or more keyhole markup language KML files that define geographic features of locations on Earth. Directions can be generated to route the user to the field and indicate sensitive areas along the route to avoid. In one embodiment, farmer field definitions can be uploaded, including shape files and other GIS locators for use in “tagging” activities during the completion of the crop cycle and aggregate activities across the production cycle to these geographic field identifiers. By geotagging activities (e.g. treating a field with a pesticide), the activities performed on a field can be directly linked to the physical location of the activity, and such data can be kept and later used to check provenance and/or analytics.

Data Vector

The data vector 113 can be generated and updated by any of the nodes and can be stored on any of the nodes or on a dedicated storage managed by a dedicated server. The data vector can include all the notifications, verifications, and timestamps pertaining to the performance of the treatment ticket, and all the data of the treatment ticket itself. Multiple data vectors can be aggregated and sorted in a database. An analytics engine 114 can access the aggregated data vectors to generate new insights, graphs, data summaries, and more, relating to treatment of fields or a particular field. The stored data vector can provide provenance of the activities on the farm on a per-field basis.

### III. Privileges and Verifications

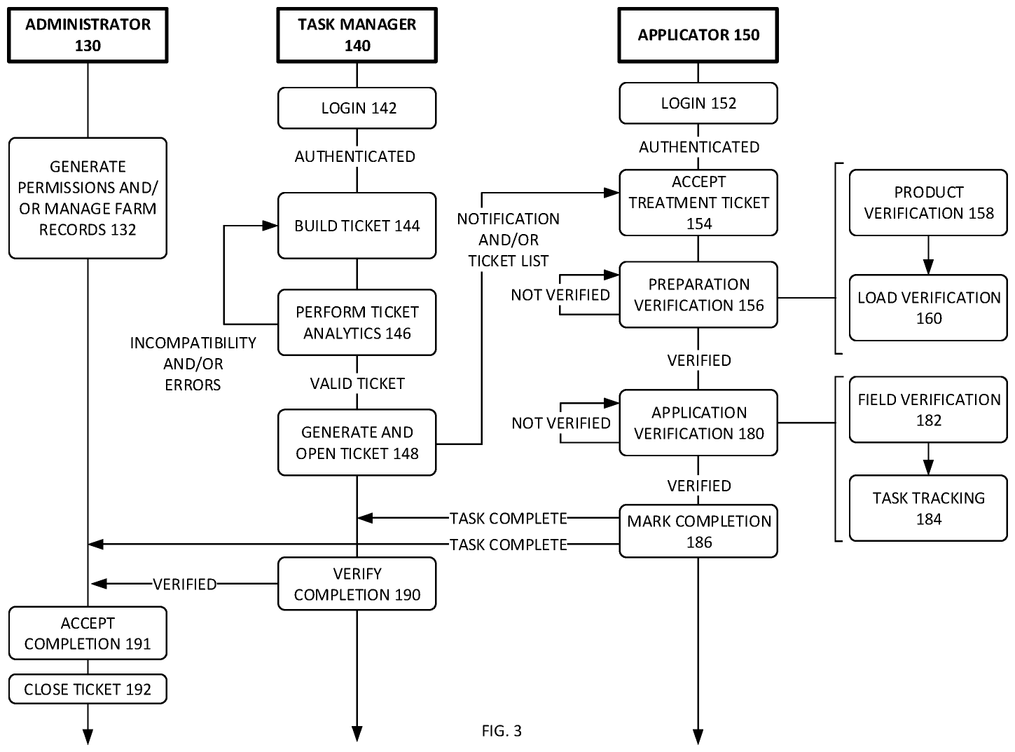

In one aspect of the present disclosure, a method is disclosed as shown in FIG. 3 that uses privileges/permissions and verifications to build a treatment ticket with the proper instructions and products, and ensure the correct people are carrying out the assigned task in the proper manner specified by the treatment ticket.

An administrator 130 can generate permissions and/or manage farm records 132. The farm records can be stored in a farm database and can specify the names and license numbers of all farm employees. The administrator can also assign and modify privileges such as: which treatment products and tasks each employee can handle and perform; which employees can supervise the completion of a task; and which employees can generate treatment tickets.

A task manager 140 can log in 142 to a node and, if the manager has the proper privileges, then the manager can begin building the ticket 144, e.g., through a user interface. The ticket can include instructions specifying who will perform the task, what treatment products should be used, and where and when to apply the product.

Ticket analytics 146 can be performed to determine any incompatibilities with the products, errors in the mixing instructions, or violations of requirements of the field or crop. If such incompatibilities or errors exist, then the task manager can be notified of the issues so that the task manager can make the proper corrections to the ticket. If the ticket analytics determine that the ticket is valid, then the node can generate and open the ticket 148.

A notification can be sent to the assigned employee of the task and/or the ticket can be populated to a ticket list. An applicator (e.g., the assigned employee) can login 152 to a node and accept the treatment ticket. In one embodiment, the ticket does not have a named employee and any employee of the farm can pick up the ticket.

The node can perform preparation verification 156 which can be described as two separate functions—a product verification step 158 and a load verification step 160.

In product verification block 158, the user can use the node (which can be a device with camera) to scan the label of a treatment product. The node can confirm that scanned label or labels is consistent with the specified treatment product or products of the treatment ticket. The block verifies that the correct product is being used.

In load verification block 160, the user can be prompted to input the total quantity of the product used. The user can then enter the quantity that the user has dumped into a mixing/storage tank to be used for the treatment. The node can confirm whether this amount is correct, based on the acreage of the field and the spray rate or quantity specified in the ticket. The node can provide an option to the user to review the downloaded label of the treatment product, and generate special instructions or hazards in relation to the task. The node can require the user to upload a photo of PPE to be used in the task, to ensure safe handling. The block verifies that the correct quantity of product has been loaded, and that the handling instructions are followed.

In one embodiment, one or more of the above items may be required to verify the product preparation 156. In another embodiment, all of the above items may be required. This can be configured by the administrator or by task manager 140 on a per-ticket basis. If, for example, a product is not on hand, the user can let the task manager know and the task manager can generate a new ticket. Once preparation is verified, the node can return an application/spray approval (e.g. in the form of a notification on the user interface) and the user can move on to the application verification block 180. This block can include a field verification block 182 and a task tracking block 184.

In field verification block 182, the node can use a GPS location and a date and time to verify that the location of the application is consistent with the field or a well that irrigates to the field. The date and time can be cross-referenced against a date and time of application assigned specified in the treatment ticket. The node can provide a notification if the criteria are satisfied, and provide control inputs such as ‘start’ and ‘stop’ buttons that will allow the user to track the real-time application of the treatment products to the field.

In the task tracking block 184, the user can log the application of the treatment products in real-time (e.g. with a start and stop button) with GPS tracking. In one embodiment, the node may require that the user upload a picture of the field or site of application, prior to completion.

In one embodiment, once the user marks the task complete 186, a notification can be generated and sent to the task manager 140 and/or to the administrator 130. The task manager or a farm supervisor that is named on the treatment ticket, verify completion 190 of the task. This can be enough to mark the ticket as ‘closed’. In another embodiment, however, the supervisor's verification can be sent to an administrator. The administrator can accept completion 191, and close the ticket 192.

In one embodiment, the ticket has a status indicator that is ‘open’ after block 148, ‘in progress’ after block 156, ‘complete’ after block 180, and ‘closed’ after block 192.

Computer Program Product

A computer program product, comprising instructions that embody the methods described herein for treatment of fields is provided. In some embodiments, the computer program product is designed to run on a mobile device (i.e., a mobile application or “app”). Such a mobile app can be designed to function with certain mobile operating systems, such as Apple iOS, Google Android, Samsung's Bada, Research in Motion's BlackBerry OS, and Microsoft's Windows Mobile. In those embodiments wherein the computer program product is a mobile app, the methods provided herein further comprise a step of downloading and installing the mobile app on a mobile device prior to use thereof. In some of these embodiments, the packaging of the agricultural product provides instructions for downloading such a mobile app (e.g., where the mobile app can be found, such as an app store). In certain embodiments, the downloading instructions are provided in multiple languages on the agricultural product packaging.

Health and Safety Analytics Framework

An analytics framework for maintaining health and safety of agricultural products is disclosed. By capturing the totality of the agricultural treatment can include chemical and biological treatments on the crop and field through the system and method described, an analytics engine 114 can “certify” farmer practice for compliance with health and safety requirements, thereby improving the health and safety of the crop. In one embodiment, the process includes:

1. Linking products and time of application to critical labeling requirements and restrictions—these could include, re-entry interval, pre-harvest interval, total active ingredients (AI) load per crop and season, monitoring integrated pest management (IPM) and resistance management strategies, maximum residue limits for known export markets, and labelled and off labelled applications. These requirements and restrictions can be contained in label information or other public sources, such as one or more public databases that are accessible over a network, for essentially all registered pesticide products. Where special definitions of IPM, low residue or other practice is defined by consultants or buyers, these requirements can be loaded as special cases in one or more databases within the analytic framework and computed and tracked where necessary

2. Developing an industry accepted compliance standard certification, supported by the technology described herein—product usage together with stored parameters in an overall analytical framework to calculate a current “status” for each field and constitute a generally accepted compliance standard that would be accepted by both sellers and buyers.

3. Push and pull information—Giving “push” notifications back to farmers on status of individual fields for re-entry, harvest and overall compliance could provide a currently unavailable level of value add. Product could have a matching certificate of compliance with any defined standard at any time throughout the production season. In effect, the farmer could know before harvest that the crop is in alignment with a buyer's health and safety requirements. Whether or not the crop is in alignment with the buyer's parameters can be shared through a notification with the buyer.

4. Returning the minimum data required for certification—in one embodiment, a computing device can return a defined minimum data required for certification. The minimum data requirement can in the form of a compliance ‘vector’, for example, a string of yes/no elements corresponding to status of key certification elements or requirements. An analytic engine, running on a computing device, can access and process the data relating to the totality of the farmer practice. Based on the analysis performed by the analytic engine on the data (which can be updated continuously and in real-time so that the data reflects the current state of the farmer practice), the computing device can update this compliance vector that incorporates these items.

For example, the analytics can scan every data point relating to a batch or a lot/field, throughout the time to determine if there has been an off label application. If an off label application is found, then the analytics engine mark the corresponding data element with an indicator. An ‘off label’ application or treatment describes a use of a treatment substance where the use is not supported by the label of the treatment substance and/or a label of the treated crop. In an interactive mode, the farmer might be able to enter a next pesticide application sequence, prior to application, and model what effect it would have on the health and safety status.

Non-limiting embodiments of the invention include:

1. A method, implemented by one or more processors, for treating a farm field with health and safety, comprising:

accepting, by an authenticated user, a treatment ticket, the treatment ticket including a) one or more treatment products to be applied to a field in a farm, b) optionally, a quantity of the treatment product, and c) a field identifier of the field on which the one or more treatment products are to be applied;

verifying a preparation of the one or more treatment products, including scanning of a label of one or more physical treatment products;

verifying an application of the one or more treatment products at the field, including storing a geolocation of the authenticated user; and

generating a data vector, the data vector including, i) verification of the preparation of the one or more treatment products, and ii) verification of the application of the treatment product at the field.

2. The method of embodiment 1, wherein
the treatment ticket further includes one or more named treatment product applicators, and
acceptance of the treatment ticket is permitted only if the authenticated user is verified to be included in the one or more named treatment product applicators.
   3. The method as in one of embodiments 1-2, wherein the treatment ticket further includes a machine or well with which the treatment product is to be used to administer the chemical treatment, and/or an application rate of the treatment product.
   4. The method as in one of embodiments 1-3, wherein generating of the treatment ticket includes
determining whether the one or more treatment products violate one or more requirements based on the field, a crop in the field, or a mixture limitation, and
generating a notification if such a determination is positive.
   5. The method of embodiment 4, wherein determining whether the one or more treatment products violate one or more requirements is further based on whether past treatments of the field, when combined with the one or more treatment products, would violate the one or more requirements.
   6. The method as in one of embodiments 1-5, wherein the treatment ticket includes PPE, PHI, or REI.
   7. The method as in one of embodiments 1-6, wherein the authenticated user is specified in the treatment ticket to apply the one or more treatment products.
   8. The method of embodiment 7, wherein the authenticated user is notified of the treatment ticket through a user interface notification.
   9. The method as in one of embodiments 1-8, wherein the label includes one or more of the following: a bar code, a quick response code, a product name or identifier, or a product EPA registration number.
   10. The method as in one of embodiments 1-9, wherein verifying the preparation of the one or more treatment products includes cross-referencing the scanned label of the one or more physical treatment products with the one or more treatment products of the treatment ticket to determine whether the one or more physical treatment products are consistent with the one or more treatment products of the treatment ticket.
   11. The method of embodiment 10, wherein, if it is determined that the one or more physical treatment products are consistent with the one or more treatment products of the treatment ticket, then
a confirmation is returned to the authenticated user on a user interface, and
the authenticated user is provided with a) a user interface notification that the user can proceed to a loading of the one or more treatment products or b) a user interface control to confirm a loading of the one or more treatment products in a preparation container.
   12. The method of embodiment 11, wherein
verifying the preparation of the one or more treatment products includes
   receiving a confirmation, by the authenticated user through the user interface control, of the loading of the one or more treatment products in a preparation container; and
   generating an application approval based on the confirmation of the load.
      13. The method of embodiment 12, wherein verifying the application of the one or more treatment products is performed only upon the application approval.
      14. The method as in one of embodiments 1-13, further comprising generating a photo of PPE during the preparation of the one or more treatment products, wherein the photo is stored in electronic memory and associated with the data vector.
      15. The method as in one of embodiments 1-14, wherein storing the geolocation of the application is performed with a GPS module.
      16. The method as in one of embodiments 1-15, wherein verifying the application of the one or more treatment products at the field includes cross-referencing the geolocation of the user with a known location of the field.
      17. The method as in one of embodiments 1-16, wherein verifying the application of the one or more treatment products includes confirming an application of the one or more treatment products, with one or more user interface inputs, and generating a data point based on the user interface input that includes a timestamp and the geolocation of the authenticated user.
      18. The method as in one of embodiments 1-17, wherein the data vector and/or the treatment ticket includes a status indicator of the treatment ticket, the status indicator including a) ‘open’, b) ‘in progress’, c) ‘complete’, or d) ‘closed’.
      19. The method of embodiment 18, wherein the status indicator is a) initialized to ‘open’ when the treatment ticket is generated, b) updated to ‘in progress’ in response to verifying the preparation of the one or more treatment products, c) updated to ‘complete’ upon verifying the application of the one or more treatment products, and d) updated to ‘closed’ in response to verifying the application of the one or more treatment products.
      20. The method as in one of embodiments 1-19, wherein the authenticated user is authenticated based on an applicator device identifier, the applicator device identifier being a unique identifier assigned to a device used by the authenticated user to accept the treatment ticket.
      21. The method as in one of embodiments 1-20, wherein the device includes a sensor used to perform the scanning of the label and a GPS module used in storing the geolocation of the authenticated user.
      22. The method as in one of embodiments 1-21, wherein
the treatment ticket further includes one or more named supervisors;
a notification is pushed out to the one or more named supervisors upon verifying the application of the one or more treatment products, and
a verification is received from the one or more named supervisors acknowledging the application of the one or more treatment products.
   23. The method of embodiment 22, wherein
a notification is pushed out to an authorized administrator upon verifying the application of the one or more treatment products by the supervisor, and
an acceptance is received from the authorized administrator.
   24. The method of embodiment 23, wherein the treatment ticket is closed upon receiving a) the verification from the one or more named supervisors and/or b) the acceptance from the authorized administrator.
   25. The method as in one of embodiments 1-24, further comprising
maintaining a farm database that has write-privileges restricted only to an authorized administrator, the database including one or more of the following:
name of the farm;
location of the farm;
a name or identifier of the authorized administrator.
   26. The method as in one of embodiments 1-25, further comprising
maintaining a database that has write-privileges restricted only to an authorized administrator, the database including one or more of the following:
a list of fields of the farm,
a geolocation of each field of the farm,
one or more harvest dates,
farm compliance requirements,
one or more field identifiers.
   27. The method as in one of embodiments 1-26, further comprising
maintaining a database that has write-privileges restricted only to an authorized administrator, the database including one or more of the following:
an employee roster of the farm including one or more farm supervisors;
   one or more treatment product applicators; and
   one or more applicator device identifiers.
      28. The method of embodiment 27, wherein the treatment ticket can only be generated by the one or more farm supervisors and can only be accepted by the one or more treatment product applicators.
      29. The method as in one of embodiments 1-28, further comprising
maintaining a database that has write-privileges restricted only to an authorized administrator, the database including one or more of the following:
farm spray equipment;
capabilities of the farm spray equipment;
chemigation well equipment;
chemigation well identifier;
chemigation well nickname;
well inspection number.
   30. A mobile device for providing health and safety of an agricultural product, comprising:
a non-transitory machine readable storage medium having stored therein instructions that, when executed by a processor, perform a method of any one of embodiments 1-29.
   31. The mobile device according to embodiment 30, wherein the instructions of embodiment 30 are stored in memory on a networked server, and are retrieved through the network by the machine and loaded into the non-transitory machine readable storage medium, to be executed by the processor.
   32. A non-transitory machine readable storage medium having stored therein instructions that, when executed by a processor, perform a method of any one of embodiments 1-29.
   33. A system comprising one or more networked nodes, each node comprising
a non-transitory machine readable storage medium having stored therein instructions that, when executed by a processor of the node, perform a method of any one of embodiments 1-29.
   34. The system according to embodiment 33, wherein the one or more networked nodes includes an administrative node is used to maintain the database according to claims 25, 26, 27 and 29.
   35. The system as in one of embodiments 33-34, wherein the one or more networked nodes includes a task management node, used to generate the treatment ticket.
   36. The system as in one of embodiments 33-35, wherein
the one or more networked nodes includes an applicator node, and
the applicator node performs the accepting of the treatment ticket, the verifying of the preparation, and the verifying of the application.

What is claimed is:

1. A method, implemented by one or more processors, for treating a farm field with health and safety, comprising:
accepting, by an authenticated user, a treatment ticket, the treatment ticket including a) one or more treatment products to be applied to a field in a farm, b) optionally, a quantity of the treatment product, and c) a field identifier of the field on which the one or more treatment products are to be applied;
verifying a preparation of the one or more treatment products, including scanning of a label of one or more physical treatment products;
verifying an application of the one or more treatment products at the field, including storing a geolocation of the authenticated user; and
generating a data vector, the data vector including, i) verification of the preparation of the one or more treatment products, and ii) verification of the application of the treatment product at the field.

2. The method of claim 1, wherein
the treatment ticket further includes one or more named treatment product applicators, and
acceptance of the treatment ticket is permitted only if the authenticated user is verified to be included in the one or more named treatment product applicators.

3. The method of claim 1, wherein the treatment ticket further includes a machine or well with which the treatment product is to be used to administer the chemical treatment, and/or an application rate of the treatment product.

4. The method of claim 1, wherein generating of the treatment ticket includes
determining whether the one or more treatment products violate one or more requirements based on the field, a crop in the field, or a mixture limitation, and
generating a notification if such a determination is positive.

5. The method of claim 4, wherein determining whether the one or more treatment products violate one or more requirements is further based on whether past treatments of the field, when combined with the one or more treatment products, would violate the one or more requirements.

6. The method of claim 5, wherein the treatment ticket includes PPE, PHI, or REI.

7. The method of claim 1, wherein the authenticated user is specified in the treatment ticket to apply the one or more treatment products.

8. The method of claim 7, wherein the authenticated user is notified of the treatment ticket through a user interface notification.

9. The method of claim 1, wherein the label includes one or more of the following: a bar code, a quick response code, a product name or identifier, or a product EPA registration number.

10. The method of claim 1, wherein verifying the preparation of the one or more treatment products includes cross-referencing the scanned label of the one or more physical treatment products with the one or more treatment products of the treatment ticket to determine whether the one or more physical treatment products are consistent with the one or more treatment products of the treatment ticket.

11. The method of claim 10, wherein, if it is determined that the one or more physical treatment products are consistent with the one or more treatment products of the treatment ticket, then
a confirmation is returned to the authenticated user on a user interface, and
the authenticated user is provided with a) a user interface notification that the user can proceed to a loading of the one or more treatment products or b) a user interface control to confirm a loading of the one or more treatment products in a preparation container.

12. The method of claim 11, wherein
verifying the preparation of the one or more treatment products includes
receiving a confirmation, by the authenticated user through the user interface control, of the loading of the one or more treatment products in a preparation container; and
generating an application approval based on the confirmation of the load.

13. The method of claim 12, wherein verifying the application of the one or more treatment products is performed only upon the application approval.

14. The method of claim 1, further comprising generating a photo of PPE during the preparation of the one or more treatment products, wherein the photo is stored in electronic memory and associated with the data vector.

15. The method of claim 1, wherein storing the geolocation of the application is performed with a GPS module.

16. The method of claim 1, wherein verifying the application of the one or more treatment products at the field includes cross-referencing the geolocation of the user with a known location of the field.

17. The method of claim 1, wherein verifying the application of the one or more treatment products includes confirming an application of the one or more treatment products, with one or more user interface inputs, and generating a data point based on the user interface input that includes a timestamp and the geolocation of the authenticated user.

18. The method of claim 1, wherein the data vector and/or the treatment ticket includes a status indicator of the treatment ticket, the status indicator including a) ‘open’, b) ‘in progress’, c) ‘complete’, or d) ‘closed’.

19. A mobile device for providing health and safety of an agricultural product, comprising a non-transitory machine readable storage medium having stored therein instructions that, when executed by a processor, perform a process comprising
accepting, by an authenticated user, a treatment ticket, the treatment ticket including a) one or more treatment products to be applied to a field in a farm, b) optionally, a quantity of the treatment product, and c) a field identifier of the field on which the one or more treatment products are to be applied;
verifying a preparation of the one or more treatment products, including scanning of a label of one or more physical treatment products;
verifying an application of the one or more treatment products at the field, including storing a geolocation of the authenticated user; and
generating a data vector, the data vector including, i) verification of the preparation of the one or more treatment products, and ii) verification of the application of the treatment product at the field.

20. A non-transitory machine readable storage medium having stored therein instructions that, when executed by a processor, perform a method comprising:
accepting, by an authenticated user, a treatment ticket, the treatment ticket including a) one or more treatment products to be applied to a field in a farm, b) optionally, a quantity of the treatment product, and c) a field identifier of the field on which the one or more treatment products are to be applied;
verifying a preparation of the one or more treatment products, including scanning of a label of one or more physical treatment products;
verifying an application of the one or more treatment products at the field, including storing a geolocation of the authenticated user; and
generating a data vector, the data vector including, i) verification of the preparation of the one or more treatment products, and ii) verification of the application of the treatment product at the field.
